(19) United States
(12) Patent Application Publication
(10) Pub. No.: US 2008/0186597 A1
(43) Pub. Date: Aug. 7, 2008

(54) ARRANGEMENT STRUCTURE OF LENSES AND CAMERA MODULE, AND ELECTRONIC APPARATUS

(75) Inventor: Noritoshi Eguchi, Saitama (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/018,883

(22) Filed: Jan. 24, 2008

(30) Foreign Application Priority Data
Jan. 30, 2007 (JP) 2007-019703

(51) Int. Cl. G02B 7/02

(52) U.S. Cl. 359/819

(57) ABSTRACT

An arrangement structure of lenses includes two adjacent lenses, a first engagement surface formed at a surface where one lens out of the two lenses faces another lens, and a second engagement surface capable of engaging with the first engagement surface, which is formed in a surface where the another lens of the two lenses faces the one lens.

### BACKGROUND OF THE INVENTION

1. Field of the Invention

The present invention relates to an arrangement structure of lenses and a camera module, and an electronic apparatus.

2. Description of Related Art

There has been provided an electronic apparatus, such as an image capture apparatus that takes an object image guided by a photographing optical system including a plurality of lenses, through an imaging element.

In order to ensure an optical performance of the photographing optical system, the plurality of lenses need to be positioned so that optical axes thereof coincide with one another.

The positioning in a direction perpendicular to the optical axis direction of each of the lenses has been made by causing an outer peripheral surface of each lens to abut and engage with an inner peripheral surface of a cylindrical member (lens barrel) to which the lens is embedded (refer to Japanese Patent Application Publication No. JP 2006-301672, Patent Document 1).

### SUMMARY OF THE INVENTION

For example, when three lenses are embedded, it had been necessary to prepare abutting surfaces at three points in the inner peripheral portion of the cylindrical member (lens barrel) to match the optical axes of the three lenses.

In recent years, a camera module has been incorporated in a small case such as a mobile phone, and the lenses and the cylindrical member (lens barrel) have also been made smaller.

In such a situation, if the abutting surfaces for causing the optical axes of the lenses to coincide with one another are formed at a plurality of points in the inner peripheral portion of the small cylindrical member (lens barrel) as in the related art, process cost will be increased. Further, the abutting surface with high process accuracy is required for causing the optical axes of the lenses to coincide with one another with high accuracy, which disadvantageously further increases process cost.

It is desirable to provide an arrangement structure of lenses and a camera module, and an electronic apparatus in which a plurality of abutting surfaces for causing optical axes of the lenses in an inner peripheral portion of a cylindrical member (lens barrel)can be omitted in aim of cost down. The present invention is made in view of the situations.

An arrangement structure of lenses according to embodiments of the present invention includes two adjacent lenses, a first engagement surface formed on a surface where one lens out of the two lenses faces another lens, and a second engagement surface which is formed on a surface where the another lens out of the two lenses faces the one lens, and capable of engaging with the first engagement surface. The first engagement surface is formed on an annular tapered surface where the radius gradually becomes smaller as it becomes distant from the one lens with an optical axis of the one lens positioned at a center, at a point located on the radially inner side from an outer peripheral surface of the one lens. The second engagement surface is formed on an annular tapered surface where the radius gradually becomes large as it becomes distant from the another lens with an optical axis of the another lens positioned at a center, at a point located on the radially inner side from an outer peripheral surface of the another lens. The two lenses are arranged by engaging the first engagement surface and the second engagement surface.

A camera module according to embodiments of the present invention includes an imaging element and a photographing optical system that guides an object image to the imaging element. The photographing optical system includes two or more lenses, and a first engagement surface is formed on a surface where one lens out of the two lenses faces another lens. A second engagement surface is formed on a surface where the another lens out of the two lenses faces the one lens, and capable of engaging with the first engagement surface. The first engagement surface is formed on an annular tapered surface where the radius gradually becomes small as it becomes distant from the one lens with an optical axis of the one lens positioned as a center, at a point located on the radially inner side from an outer peripheral surface of the one lens. The second engagement surface is formed on an annular tapered surface where the radius gradually becomes large as it becomes distant from the another lens with an optical axis of the another lens positioned as a center, at a point located on the radially inner side from an outer peripheral surface of the another lens. The two lenses are arranged by engaging the first engagement surface and the second engagement surface.

Moreover, an electronic apparatus of the present invention has a camera module incorporated therein, and the camera module includes an imaging element, and a photographing optical system that guides an object image to the imaging element. The photographing optical system includes two or more lenses, and a first engagement surface is formed on a surface where one lens out of the two lenses faces another lens. A second engagement surface, capable of engaging with the first engagement surface, is formed on a surface where the another lens out of the two lenses faces the one lens. The first engagement surface is formed on an annular tapered surface where the radius gradually becomes small as it becomes distant from the one lens with an optical axis of the one lens positioned as a center, at a point located on the radially inner side from an outer peripheral surface of the one lens. The second engagement surface is formed on an annular tapered surface where the radius gradually becomes large as it becomes distant from the another lens with an optical axis of the another lens positioned at a center, at a point located on the radially inner side from an outer peripheral surface of the another lens. The two lenses are arranged by engaging the first engagement surface and the second engagement surface.

### BRIEF DESCRIPTION OF THE DRAWINGS

FIG. 1 is explanatory views of one example of an electronic apparatus 100 into which a cameral module 10 of an embodiment is incorporated, (A) being an external view showing a closed state where a first case 104 is superimposed on a second case 106, and (B) being an external view showing a open state where the first case 104 is opened with respect to the second case 106;

FIG. 2 is a block diagram showing a configuration of a control system of the electronic apparatus 100;

FIG. 3 is a cross-sectional view showing a configuration of the camera module 10;

FIG. 4 is a cross-sectional view showing a configuration of a lens 12;

FIG. 5 is an enlarged view of an engagement surface portion; and

FIG. 6 is an explanatory view of cutting of a gate when a lens is formed by injection molding.

### DETAILED DESCRIPTION OF THE EMBODIMENTS

First, an electronic apparatus 100 in which a camera module 10 is incorporated is described. An arrangement structure of lenses according to embodiments of the present invention is applied to the camera module 10.

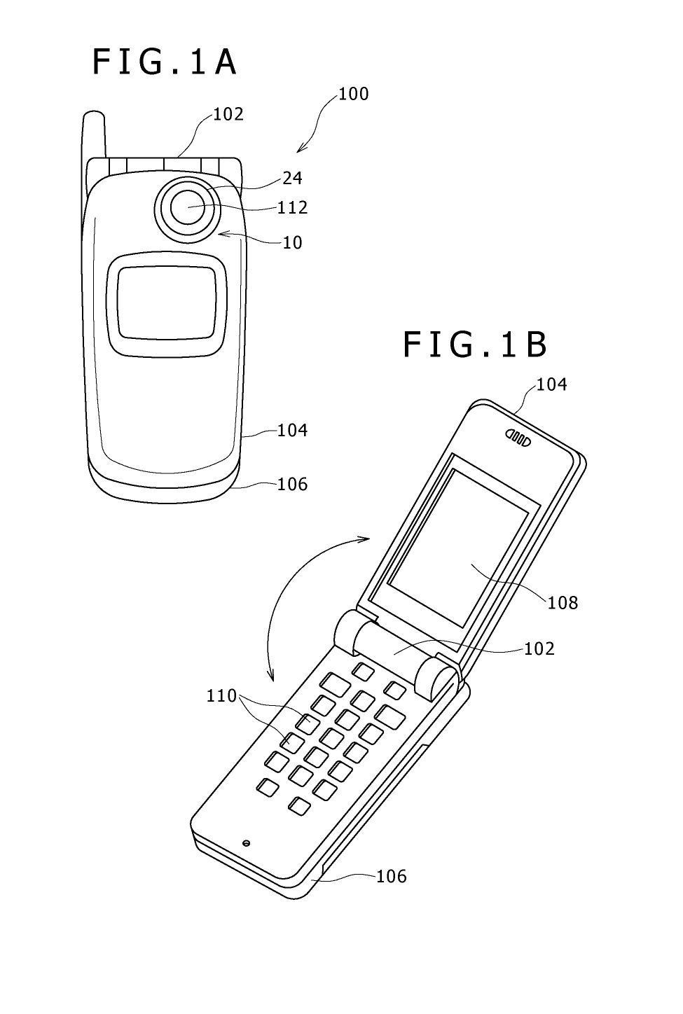

FIG. 1 is explanatory views of one example of the electronic apparatus 100 in which the camera module 10 of a first embodiment is incorporated, (A) is an external view showing a closed state where a first case 104 is superimposed on a second case 106, and (B) is an external view of a opened state where the first case 104 is opened with respect to the second case 106.

As shown in FIG. 1, in the present embodiment, the electronic apparatus 100 in which the camera module 10 is incorporated is a mobile phone.

The electronic apparatus 100 has the first and second cases 104, 106 connected non-rigidly by a hinge portion 102.

In an inner surface of the first case 104, a display 108 including a liquid crystal display panel or the like is provided, and in an inner surface of the second case 106, an operation unit 110 such as a numeric keypad and function keys is provided.

The camera module 10 is incorporated in a base end portion of the first case 104, and is configured to display an image taken by the electronic apparatus 100 to the display 108.

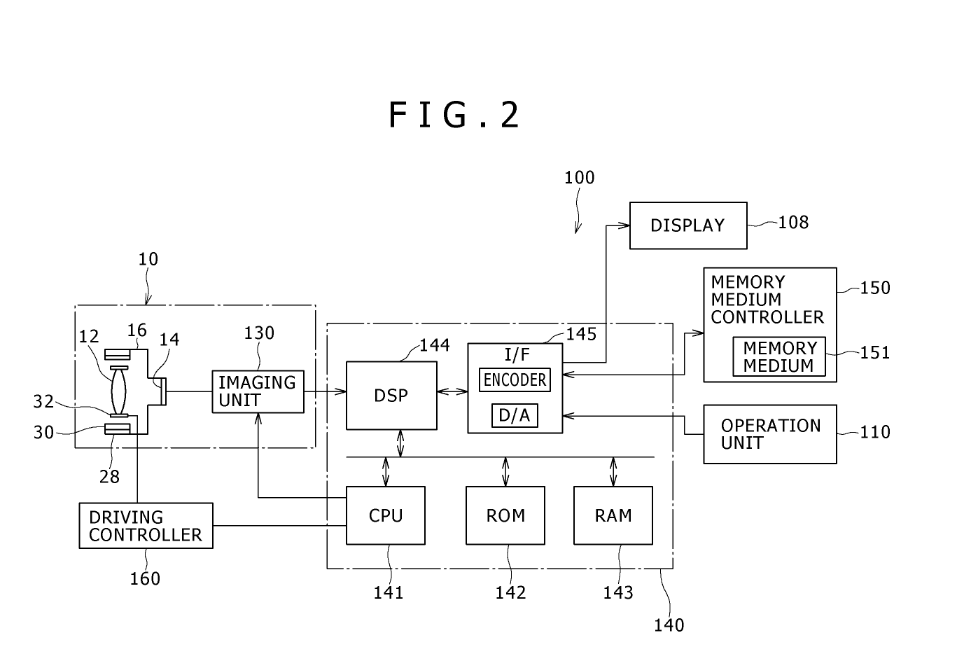

In FIG. 1(A), reference numeral 112 shows a lens cover made of a transparent material provided in front of a lens 12 (refer to FIG. 2) of the cameral module 10 incorporated in the first case 104.

FIG. 2 is a block diagram showing a configuration of a control system of the electronic apparatus 100.

The electronic apparatus 100 includes a system controller 140, a memory medium controller 150 and the like in addition to the camera module 10, the display 108, and the operation unit 110.

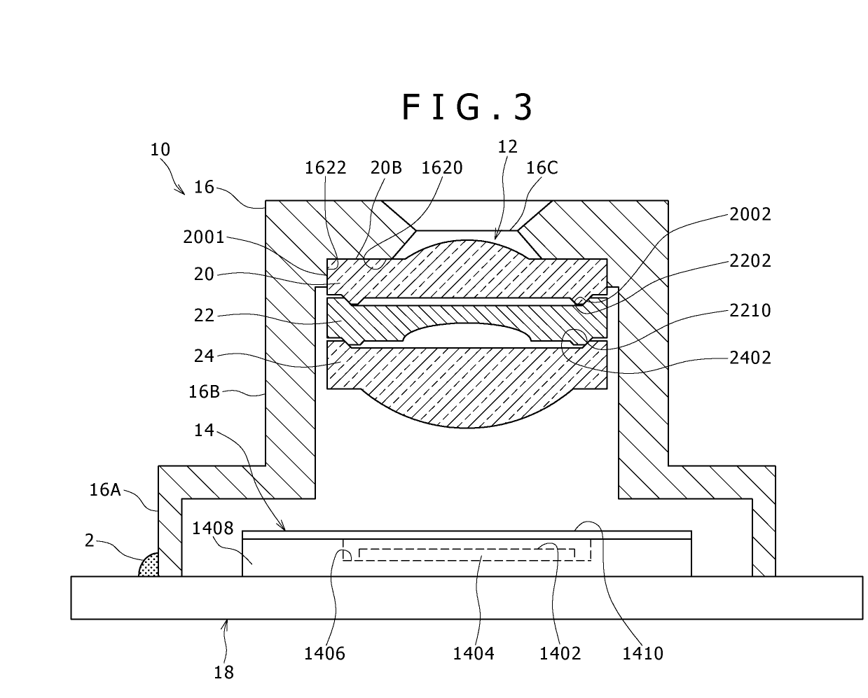

The camera module 10 includes an imaging unit 130, which is provided on a substrate 18 (refer to FIG. 3).

The imaging unit 130 takes images of an object by using an imaging element 14 of the camera module 10, and outputs an imaging signal to the system controller 140 provided on a main substrate.

More specifically, the imaging unit 130 performs processing such as Automatic Gain Control (AGC), Optical Black (OB) clamp, and Correlated Double Sampling (CDS) against output signal of imaging device to generate a digital imaging signal and output the same to the system controller 140.

The system controller 140 includes a CPU 141, a ROM 142, a RAM 143, a DSP 144, an external interface 145 and the like.

The CPU 141 sends instructions to the respective units in the electronic apparatus 100 by using the ROM 142 and the RAM 143 to control the overall system.

Moreover, the CPU 141 monitors an input signal from the operation unit 110, and based on the input contents, executes various types of operation control.

The DSP 144 generates a video signal of a still image or a moving image in a predetermined format (e.g. YUV signal or the like) by performing various types of signal processing to the imaging signal from the image capture unit 130.

The external interface 145 is provided with various encoders and D/A converters to mutually communicate various control signals or data with external elements connected to the system controller 140 (in this embodiment, the display 108, the operation unit 110, and the memory medium 151).

The memory medium controller 150 records the video signal of the still image or the moving image outputted from the system controller 140 to the memory medium 151 as image data, or reads image data from the memory medium 151 to supply to the system controller 140.

The memory medium 151 is, for example, an embedded memory undetachably incorporated into the electronic apparatus 100, or a memory card detachably mounted through a memory slot (not shown) provided in the electronic apparatus 100.

Next, a configuration of the camera module 10 is described in detail.

FIG. 3 is a sectional view showing a configuration of the camera module 10.

A camera module 10 includes the lens 12, the imaging element 14, a holder 16, and the substrate 18.

As shown in FIG. 3, the imaging element 14 is mounted on the substrate 18.

The imaging element 14 takes images of an object guided by the lens 12 forming a photographing optical system to generate an image signal.

As the imaging element 14, a CCD, a C-MOS sensor or various heretofore known imaging elements can be used.

In many cases, the imaging element 14 has an element body 1404 whereon an imaging surface 1402 to which the object image is guided is formed, a package 1408 having a housing recess portion 1406 that houses the element body 1404, and a transparent cover glass 1410 that shuts the housing depressed portion 1406 in a manner the glass covers the imaging surface 1402, and the like.

A bottom surface of the package 1408 is attached to a surface of the substrate 18 with an adhesive 2, and a connecting terminal exposed on the bottom surface of the package 1408 or a lower side portion of the package 1408, and a connecting terminal of the surface of the substrate 18 are connected by soldering.

As shown in FIG. 3, the holder 16 is provided such that it covers the package 1408 housing the imaging element 14.

The holder 16 is attached to the substrate 18 with the adhesive 2.

The holder 16 has a large-diameter portion at below side 16A which is attached to the substrate 18 and surrounds the package 1408, and a small-diameter portion at upper side 16B connected to the lower large-diameter portion 16A. At a top of the small-diameter portion at upper side 16B, an opening 16C is formed.

The lens 12 is attached to the small-diameter portion at upper side 16B.

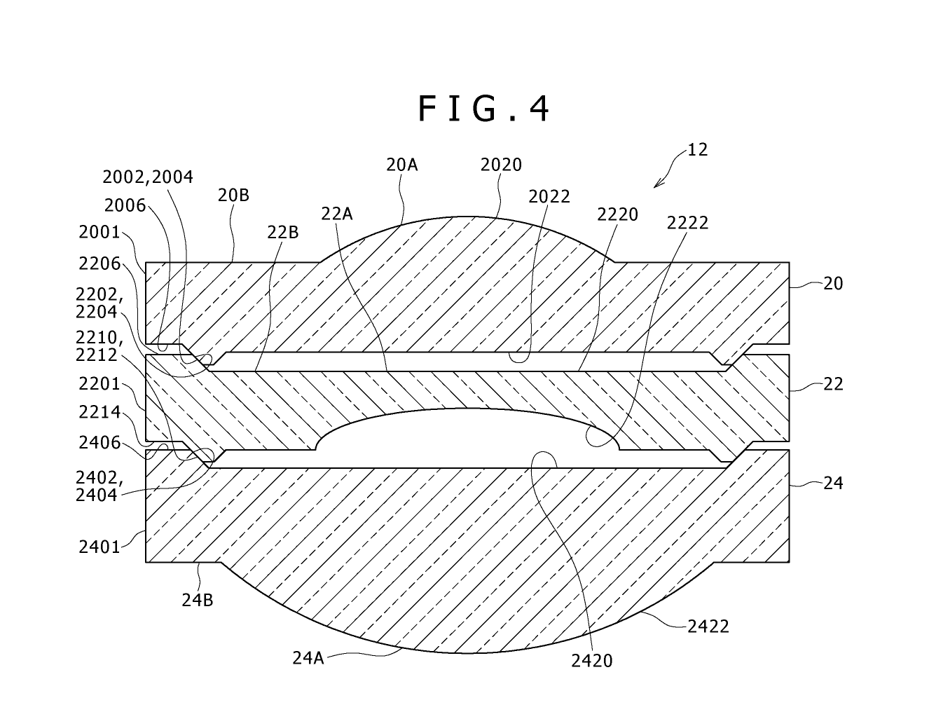

FIG. 4 is a sectional view showing a configuration of the lens 12.

In the present embodiment, as the lens 12, the following three lenses are used; a first lens 20, a second lens 22 and a third lens 24.

The first lens 20, second lens 22, and third lens 24 are arranged in this order from front to backward (from the object side to the imaging element 14 side) while the optical axes of the three lenses are adapted to coincide.

More particularly, the first lens 20 has a lens portion 20A located at the center thereof, and an attachment portion 20B located at an outside of the radial range direction of the lens portion 20A.

The lens portion 20A has a convex lens surface 2020 facing the opening 16C (refer to FIG. 3), and a flat lens surface 2022 facing the imaging element 14 (refer to FIG. 3).

A first engagement surface 2002 is formed in a face where the first lens 20 faces the second lens 22.

Particularly, an annular first projected rim 2004 is formed by swelling out, at a point closer to an outer peripheral surface 2001 and at the surface where the attachment portion 20B of the first lens 20 that faces the second lens 22.

The first engagement surface 2002 is formed in an outer peripheral portion of the first projected rim 2004.

The first engagement surface 2002 is formed at an annular tapered surface where the radius gradually becomes smaller as it becomes distant from the first lens 20 with the optical axis of the first lens 20 positioned at a center.

A first end surface portion 2006 facing the second lens 22 is located between a base end of the first engagement surface 2002, which is a point where the radius of the first engagement surface 2002 is largest, and the outer peripheral surface 2001 of the first lens 20.

The first end surface portion 2006 extends in a surface perpendicular to the optical axis of the first lens 20.

The second lens 22 has a lens portion 22A positioned at the center thereof, and an attachment portion 22B located at outside of radius range direction of the lens portion 22A.

The lens portion 22A has a flat lens surface 2220 facing the first lens 20, and a concave lens surface 2222 facing the imaging element 14.

A second engagement surface 2202 capable of engaging with the first engagement surface 2002 is formed in a surface where the second lens 22 faces the first lens 20.

Particularly, an annular second projected rim 2204 is formed by swelling out, at a position closer to an outer peripheral surface 2201, and at the surface where the attachment portion 22B of the second lens 22 faces the first lens 20.

The second engagement surface 2202 is formed at an inner peripheral portion of the second projected rim 2204.

The second engagement surface 2202 is formed at an annular tapered surface where the radius gradually becomes larger as it becomes distant from the second lens 22 with the optical axis of the second lens 22 positioned at a center.

A second end surface portion 2206 facing the first lens 20 is located between a tip end of the second engagement surface 2202, which is a point where the radius of the second engagement surface 2202 is largest, and the outer peripheral surface 2201 of the second lens 22.

The second end surface portion 2206 extends in a surface perpendicular to the optical axis of the second lens 22.

A third engagement surface 2210 is formed at a surface where the second lens 22 faces the third lens 24.

Particularly, an annular third projected rim 2212 is formed by swelling out, at a point closer to an outer peripheral surface 2201, at the surface where the attachment portion of the second lens 22 faces the third lens 24.

The third engagement surface 2210 is formed at an outer peripheral portion of the third projected rim 2212.

The third engagement surface 2210 is formed at an annular tapered surface, where the radius gradually becomes smaller as it becomes distant from the second lens 22 with the optical axis of the second lens 22 positioned at a center.

A third end surface portion 2214 facing the third lens 24 is located between a base end of the third engagement surface 2210, which is a point where the radius of the third engagement surface 2210 is largest and the outer peripheral surface 2201 of the second lens 22.

The third end surface portion 2214 extends in a surface perpendicular to the optical axis of the second lens 22.

The third lens 24 has a lens portion 24A located at the center thereof, and an attachment portion 24B located at outside of radius range direction of the lens portion 24A.

The lens portion 24A has a flat lens surface 2420 facing the second lens 22, and a convex lens surface 2422 facing the imaging element 14 (refer to FIG. 3).

A fourth engagement surface 2402 capable of engaging with the third engagement surface 2210 is formed at a surface where the third lens 24 faces the second lens 22.

Particularly, an annular fourth projected rim 2404 is formed by swelling out, at a point closer to an outer peripheral surface 2401, at the surface where the attachment portion 24B of the third lens 24 that faces the second lens 22.

The fourth engagement surface 2402 is formed at an inner peripheral portion of the fourth projected rim 2404.

The fourth engagement surface 2402 is formed at an annular tapered surface, where the radius gradually becomes large as it becomes distant from the third lens 24 with the optical axis of the third lens 24 positioned at a center.

A fourth end surface portion 2406 facing the second lens 22 is located between a tip of the fourth engagement surface 2402, which is a point where the radius of the fourth engagement surface 2402 is largest, and the outer peripheral surface 2401 of the third lens 24.

The fourth end surface portion 2406 extends in a surface perpendicular to the optical axis of the third lens 24.

In the first, second and third lenses 20, 22, 24, the optical axes thereof are not caused to coincide with one another by engaging the outer peripheral surfaces of the lenses 20, 22, 24 with the inner peripheral surface of the cylindrical member (lens barrel), but as shown in FIG. 4, the optical axes are caused to coincide by engaging the adjacent first, second and third lenses 20, 22, 24 with one another.

First, the arrangement of the first lens 20 and the second lens 22 is described.

The engagement of the first engagement surface 2002 of the first lens 20 with the second engagement surface 2202 of the second lens 22 allows the optical axes of the first lens 20 and the second lens 22 to coincide with each other, and at the same time, a space in the optical axis direction between the lens portion 20A of the first lens 20 and the lens portion 22A of the second lens 22 is determined.

In the engaged state, a clearance between the lens surface 2022 and the lens surface 2220 is secured, and a clearance between the first end surface portion 2006 and the second end surface portion 2206 is secured.

In other words, for the first lens 20 and the second lens 22, the positioning of the direction perpendicular to the optical axis and the positioning of the optical axis direction are simultaneously performed.

Next, the arrangement of the second lens 22 and the third lens 24 is described.

By engaging the fourth engagement surface 2402 of the third lens 24 with the third engagement surface 2210 of the second lens 22 in a state where the positioning of the first lens 20 and the second lens 22 is performed, the optical axes of the second lens 22 and the third lens 24 are caused to coincide with each other, and at the same time, a space between the lens portion 22A of the second lens 22 and the lens portion 24A of the third lens 24 in the optical axis direction is determined.

In the engaged state, a clearance between the lens surface 2222 and the lens surface 2420 is secured, and a clearance between the third end surface portion 2214 and the fourth end surface portion 2406 is secured.

In other words, for the second lens 22 and the third lens 24, the positioning of the direction perpendicular to the optical axis and the positioning of the optical axis direction are simultaneously performed.

As a result, the optical axes of the first, second and third lenses 20, 22, 24 are caused to coincide with one another, and the positioning of the lens portions 20A, 22A, 24A in the optical axis direction is performed. In other words, the engagement of the lenses 20, 22, 24 one another allows the optical axes thereof to coincide.

The first, second and third lenses 20, 22, 24 are adhered with an adhesive one another, and whereby the assembling of the lens 12 is completed. As the adhesive, for example, a UV-curing adhesive can be used.

As shown in FIG. 3, the assembled lens 12 is attached to the small-diameter portion at upper side 16B of the holder 16.

Particularly, in the small-diameter portion at upper side 16B, an annular engagement surface 1620 facing the imaging element 14 is formed around the opening 16C, and a cylindrical engagement surface 1622 connected to the engagement surface 1620 is formed.

The attachment portion 20B of the first lens 20 is engaged with the engagement surface 1620 of the small-diameter portion at upper side 16B, and the outer peripheral surface 2001 of the first lens 20 is engaged with the engagement surface 1622 of the small-diameter portion at upper side 16B, and whereby the positioning of the first, second, and third lenses 20, 22, 24 with respect to the small-diameter portion at upper side 16B is performed, and in this state, the first lens 20 is attached to the small-diameter portion at upper side 16B with the adhesive.

The mounting of the lens 12 to the holder 16 may be performed by fixing the first, second and third lenses 20, 22, 24 in this order to the holder 16.

As shown in FIGS. 3 and 4, the first lens 20 is engaged with the small-diameter portion at upper side 16B through the engagement surface 1620, the surface of the attachment portion 20B, the engagement surface 1622, and the outer peripheral surface 2001 to be fixed by the adhesive.

Subsequently, the second lens 22 is engaged with the first lens 20 through the first and second engagement surfaces 2002, 2202 to be fixed to the first lens 20 with the adhesive.

Similarly, the third lens 24 is engaged with the second lens 22 through the third and fourth engagement surfaces 2210, 2402 to be fixed to the second lens 22 with the adhesive.

In this manner, the lens 12 may be mounted to the holder 16.

According to the present embodiment, by engaging the engagement surfaces of the two adjacent lenses, the optical axes of the two lenses may be caused to coincide easily and simply.

Accordingly, as compared with the related art structure where outer peripheral surfaces of respective lenses are abutted to a plurality of abutting surfaces of an inner peripheral portion of a cylindrical member (lens barrel) and engaged with the same to perform positioning the direction perpendicular to the optical axis direction of the respective lenses, the positioning accuracy of the lenses can be obviously secured, and the cylindrical member is not required, thus it becomes advantageous in reducing process cost and components cost, and realizing the downsizing. In particular, the cylindrical member in the related art needs to be provided with the abutting surfaces for positioning the lenses, and the abutting surfaces with high process accuracy for causing the optical axes of the lenses to coincide at high accuracy were required. Thus, while there had been a disadvantage of increased process cost, conversely in the present embodiment, such cylindrical member is not required, and therefore, there is a further advantage in reducing the process cost and the part cost.

Moreover, according to the present embodiment, by engaging the engagement surfaces of the two adjacent lenses, the optical axes of the two lenses may be caused to coincide, and at the same time, positioning of the two lenses in the optical axis direction may be allowed.

Accordingly, since there is no necessity to prepare an adjustment mechanism for positioning the lenses in the optical axis direction, or to position the lenses in the optical axis direction by using a special jig, the part cost and assembling cost may be further advantageously reduced.

Next, shapes of the engagement surfaces of the lenses are further described.

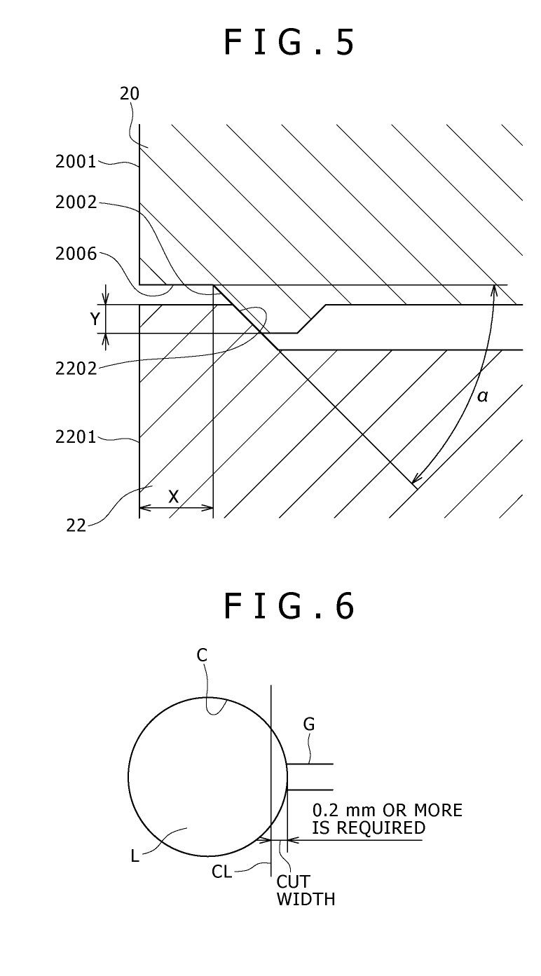

FIG. 5 is an enlarged view of the engagement surface portion, FIG. 6 is an explanatory view of cutting of a gate when a lens is formed by injection molding.

As shown in FIG. 6, when a lens L is formed of synthetic resin by way of injection molding, since the synthetic resin in a melting state is flown into a cavity C from a gate G, a portion of the synthetic resin charged into the cavity C in the vicinity of the gate G is cut off along a cut line CL shown in FIG. 6 in order to remove a projection corresponding to the gate G, and thus, a cut width of 0.2 mm or more is necessary.

The first lens 20 is described as one example.

As shown in FIG. 5, in the present embodiment, the first end surface portion 2006 facing the second lens 22 is located between the base end of the first engagement surface 2002, which is the point where the radius of the first engagement surface 2002 is largest, and the outer peripheral surface 2001, and a width X of the first end surface portion 2006 along the radial direction of the first lens 20 is 0.2 mm or more.

Thus, there does not arise a defect of cutting off the first engagement surface 2002 along the cut line CL (refer to FIG. 6).

It is more preferable if the width of the first end surface portion 2006 along the radial direction of the first lens 20 be 0.3 mm or more.

The situation is similar in the second lens 22 and the third lens 24.

Moreover, according to the present embodiment, an angle α of the first engagement surface 2002 and the second engagement surface 2202 with respect to the plane perpendicular to the optical axis of the lenses is set to not less than 30 degrees and not more than 70 degrees.

If this angle α is small, the diameter of the engagement surfaces 2002, 2202 becomes large, which is disadvantageous to the downsizing. On the contrary, if it is too large, a dimension error becomes large, leading to deterioration in fitting accuracy.

From this view, the angle α of the first engagement surface 2002 and the second engagement surface 2202 with respect to the plane perpendicular to the optical axis of the lenses is preferably set to not less than 30 degrees and not more than 70 degrees, more preferably to not less than 45 degrees and not more than 60 degrees.

The situation is similar in the second lens 22 and the third lens 24.

Moreover, in the present embodiment, in the state where the first engagement surface 2002 and the second engagement surface 2202 are engaged, a length Y of the engaged portion along the optical axis is set to be not less than 30 μm and not more than 100 μm. If this length Y is small, an engagement area cannot be secured, thereby deteriorating the fitting accuracy.

Moreover, if the lens is inserted strongly, the lens cannot endure the strong force and thus damaged.

If the length Y is too large, the high accuracy of the fitting cannot be attained, thereby resulting in an increase in cost.

Accordingly, this length is preferably set to not less than 30 μm and not more than 100 μm.

It is more preferably that this length Y be not less than 40 μm and not more than 60 μm.

The situation is similar in the second lens 22 and the third lens 24.

While in the present embodiment, the case where the lens 12 is unmovably attached to the holder 16 is described, the lens 12 may be provided movably in the optical axis direction with respect to the holder 16.

Moreover, although in the present embodiment, the case where the electronic apparatus 100 into which the camera module 10 is incorporated is a portable telephone is described, the camera module 10 of the present invention can be widely applied to various electronic apparatuses, such as a handheld terminal, such as a PDA and a laptop personal computer, for example, and a digital still camera, a video camera and the like. Furthermore, the arrangement structure of the lenses in embodiments of the present invention can be widely applied to optical systems of various apparatuses.

According to the present invention, by engaging the engagement surfaces of the two adjacent lenses with each other, the optical axes of the two lenses are coincided, and at the same time, the positioning of the two lenses in the optical axis direction can be determined.

Accordingly, the positioning accuracy of the lens can be obviously secured, and the cylindrical member in the related art is not required, thus it becomes advantageous in reducing process cost and component cost, and realizing the downsizing.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-019703 filed in the Japanese Patent Office on Jan. 30, 2007, the entire content of which being incorporated herein by reference.

What is claimed is:

1. An arrangement structure of lenses comprising:
two adjacent lenses;
a first engagement surface formed at a surface where one lens out of the two lenses faces another lens; and
a second engagement surface capable of engaging with the first engagement surface, which is formed in a surface where the another lens of the two lenses faces the one lens, wherein;
the first engagement surface is formed at an annular tapered surface where the radius gradually becomes small as it becomes distant from the one lens with an optical axis of the one lens positioned at a center, at a point located on the radially inner side from an outer peripheral surface of the one lens;
the second engagement surface is formed at an annular tapered surface where the radius gradually becomes large as it becomes distant from the another lens with an optical axis of the another lens positioned at a center, at a point located on the radially inner side from an outer peripheral surface of the another lens; and
the two lenses are arranged by engaging the first engagement surface and the second engagement surface.

2. The arrangement structure of lenses according to claim 1, wherein:
an annular first projected rim is formed in a swell out state, at a point closer to the outer peripheral surface and at the surface where the one lens out of the two lenses faces the another lens;
the first engagement surface is formed in an outer peripheral portion of the first projected rim;
an annular second projected rim is formed in a swell out state, at an outer peripheral portion in the surface where the another lens out of the two lenses faces the one lens; and
the second engagement surface is formed in an inner peripheral portion of the second projected rim.

3. The arrangement structure of lenses according to claim 1, wherein:
a first end surface portion facing the another lens is located between a base end of the first engagement surface, which is a point where the radius of the first engagement surface is largest, and the outer peripheral surface of the one lens;
a second end surface portion facing the one lens is located between a tip end of the second engagement surface, which is a point where the radius of the second engagement surface is largest, and the outer peripheral surface of the another lens; and
a clearance is secured between the first end surface portion and the second end surface portion while the first engagement surface and the second engagement surface are engaged.

4. The arrangement structure of lens according to claim 1, wherein:
each lens has a lens portion located at the center, and an attachment portion located at outside of radius range direction of the lens portion;
the first engagement surface is provided at the attachment portion of the one lens; and
the second engagement surface is provided at the attachment portion of the another lens.

5. The arrangement structure of lens according to claim 1, wherein:
a first end surface portion facing the another lens is located between a base end of the first engagement surface, which is a point where the radius of the first engagement surface is largest, and the outer peripheral surface of the one lens; and
a width of the first end surface portion along the radial direction of the one lens is 0.2 mm or more.

6. The arrangement structure of lens according to claim 1, wherein:
a first end surface portion facing the another lens is located between a base end of the first engagement surface, which is a point where the radius of the first engagement surface is largest, and the outer peripheral surface of the one lens; and
a width of the first end surface portion along the radial direction of the one lens is 0.3 mm or more.

7. The arrangement structure of lens according to claim 1, wherein:
an angle of the first engagement surface and the second engagement surface with respect to a plane perpendicular to the optical axes of the lenses is not less than 30 degrees and not more than 70 degrees.

8. The arrangement structure of lens according to claim 1, wherein:
an angle of the first engagement surface and the second engagement surface with respect to a plane perpendicular to the optical axis of the lenses is not less than 45 degrees and not more than 60 degrees.

9. The arrangement structure of lens according to claim 1, wherein:
a length of the engaged portion along the optical axis is not less than 30 μm and not more than 100 μm in a state where the first engagement surface and the second engagement surface are engaged.

10. The arrangement structure of lens according to claim 1, wherein:
a length of the engaged portion along the optical axis is not less than 40 μm and not more than 60 μm in a state where the first engagement surface and the second engagement surface are engaged.

11. A camera module comprising:
an imaging element; and
a photographing optical system that guides an object image to the imaging element, wherein;
the photographing optical system includes two or more lenses;
a first engagement surface is formed in a surface where one lens out of the two lenses faces another lens;
a second engagement surface capable of engaging with the first engagement surface, which is formed in a surface where the another lens out of the two lenses faces the one lens;
the first engagement surface is formed at an annular tapered surface where the radius gradually becomes small as it becomes distant from the one lens with an optical axis of the one lens positioned at a center, at a point located on the radially inner side from an outer peripheral surface of the one lens;
the second engagement surface is formed at an annular tapered surface where the radius gradually becomes large as it becomes distant from the another lens with an optical axis of the another lens positioned at a center, at a point located on the radially inner side from an outer peripheral surface of the another lens; and
the two lenses are arranged by engaging the first engagement surface and the second engagement surface.

12. An electronic apparatus into which a camera module is incorporated, wherein:
the camera module includes;
an imaging element; and
a photographing optical system that guides an object image to the imaging element, wherein;
the photographing optical system includes two or more lenses;
a first engagement surface is formed in a surface where one lens out of the two lenses faces another lens;
a second engagement surface capable of engaging with the first engagement surface is formed in a surface where the another lens out of the two lenses faces the one lens;
the first engagement surface is formed at an annular tapered surface where the radius gradually becomes small as it becomes distant from the one lens with an optical axis of the one lens positioned at a center, at a point located on the radially inner side from an outer peripheral surface of the one lens;
the second engagement surface is formed at an annular tapered surface where the radius gradually becomes large as it becomes distant from the another lens with an optical axis of the another lens positioned at a center, at a point located on the radially inner side from an outer peripheral surface of the another lens; and
the two lenses are arranged by engaging the first engagement surface and the second engagement surface.

13. The electronic apparatus according to claim 12, wherein:
the electronic apparatus is a mobile phone.
